(19) United States
(12) Patent Application Publication
(10) Pub. No.: US 2026/0033927 A1
(43) Pub. Date: Feb. 5, 2026

(54) APPARATUS FOR AUTOMATED SMILE DESIGN MODELING

(71) Applicant: The Ageless Smile LLC, Aspen, CO (US)

(72) Inventor: Andrew Turchin, Aspen, CO (US)

(73) Assignee: The Ageless Smile LLC, Aspen, CO (US)

(21) Appl. No.: 19/306,114

(22) Filed: Aug. 21, 2025

Related U.S. Application Data
(63) Continuation of application No. 18/789,820, filed on Jul. 31, 2024.

(51) Int. Cl. A61C 13/34; G06T 7/00; G06T 17/00; G06V 10/771; G06V 40/16

(52) U.S. Cl. CPC A61C 13/34; G06T 7/0012; G06T 17/00; G06V 10/771; G06V 40/165; G06T 2207/30036; G06V 2201/12

(57) ABSTRACT

An apparatus for automatically modeling smile design may be configured to capture a first set of facial measurements via a camera system. Using said first set of facial measurements a structural feature model may be generated. Generation of a structural feature model may include generating an initial structural feature model using at least a first set of facial measurements; identifying a plurality of ideal measurements; determining a plurality of desired changes; and applying said desired changes to the structural feature model, generating a final structural feature model. Lastly, the final structural feature model may be displayed on a display device.

### CROSS-REFERENCE TO RELATED APPLICATIONS

This application is a continuation of Non-provisional application Ser. No. 18/789,820, filed on Jul. 31, 2024, and entitled “APPARATUS FOR AUTOMATED SMILE DESIGN MODELING,” the entirety of which is incorporated herein by reference.

### FIELD OF THE INVENTION

The present invention generally relates to the field of smile esthetics and occlusion. In particular, the present invention is directed to an apparatus for automated smile design modeling.

### BACKGROUND

Facial esthetics has increasingly become highly associated with the indication of social value. The smile being an important aspect of facial esthetics has consequently made facial esthetics a key factor in dental treatment planning. Presently, the smile design modeling process lacks the ability to accurately model the ideal smile on every individual through a fully automated process. This results in a process that can take 30 minutes to 1.5 hours with each individual patient.

### SUMMARY OF THE DISCLOSURE

In an aspect, an apparatus for automatically modeling smile design may be configured to capture a first set of facial measurements via a camera system. Using said first set of facial measurements a structural feature model may be generated. Wherein generation of a structural feature model includes generating an initial structural feature model using at least a first set of facial measurements; identifying a plurality of ideal measurements, which may be identified using a data structure representing at least a stored rule that associates the first set of facial measurements with the ideal measurements; determining a plurality of desired changes, which may be identified using at least a second set of stored rules that matches the first set of facial measurements and ideal measurements to transformations to achieve ideal measurements; and applying said desired changes to the structural feature model, generating a final structural feature model. Lastly, the final structural feature model may be displayed on a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of an apparatus for automated smile design;

FIG. 2 is a before and after of a client who has implemented a treatment plan recommended by automated smile design modeling;

FIG. 3 is an exemplary machine-learning module;

FIG. 4 is an exemplary neural network;

FIG. 5 is an exemplary node of a neural network;

FIG. 6 is a flow diagram illustrating a method of automated smile design modeling;

FIG. 7 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to methods and apparatuses for an automated smile design modeling process. The automation of this process is a technological advance from the historical need for human intervention in the process of smile design. Applying a set of rules developed to create the ideal smile on any patient advances the field in various ways. Automation of this process not only shortens the design and review process, allowing for immediate review of treatment plans, it also creates more precise models and determines all possible paths of treatment. The stored rules determining any particular smile design measurement allows the automation by creating a mirror of human creativity in deciding measurements. This allows the system to model facial modifications instantly, rather than needing time for a human to make the changes manually. In an embodiment, a method and apparatus for an automated smile design modeling process is a method and apparatus configured to automatically create a structural feature model of the ideal smile. As used in this disclosure, “structural feature model” is used to describe the model that is generated based on an individual's face and captured measurements via a camera system as described below. An “ideal smile,” as used in this disclosure, is based on metrics regarding various measurements with ideal ranges decided with both function and esthetics in mind. The ideal smile is somewhat of a subjective standard, which indicates a need for user input to create a personalized perfect smile. As used in this disclosure, “perfect smile” is the generated model with both ideal measurements and desired changes applied to the model. The use of the word “smile” in describing the design of an individual's facial structure and structural dental layout does not limit the design to a smiling face. For instance, smile design will not only improve a smiling face, but will improve overall the structural schematic of an individual's face leading to improved facial structure while the face is at rest, smiling, frowning, grimacing, and the like. The use of an automated smile design modeling process may aid in demonstrating treatment paths that may be taken to reach a perfect smile outcome.

Aspects of the present disclosure can be used to streamline the process of modeling and creating treatment solutions of smile design, allowing for more efficient and accurate models and treatment methods. Aspects of the present disclosure can also be used to eliminate human error in taking and applying ideal measurements to smile design models. This is so, at least in part, because the process is automated and eliminates the need for most human intervention.

In the following description, for the purpose of explanation, numerous specific details are set forth in order to provide a thorough understanding of the present invention. Exemplary embodiments illustrating aspects of the present disclosure are described below in the context of several specific examples. Furthermore, there is no intention to be bound by any expressed or implied theory presented in this disclosure.

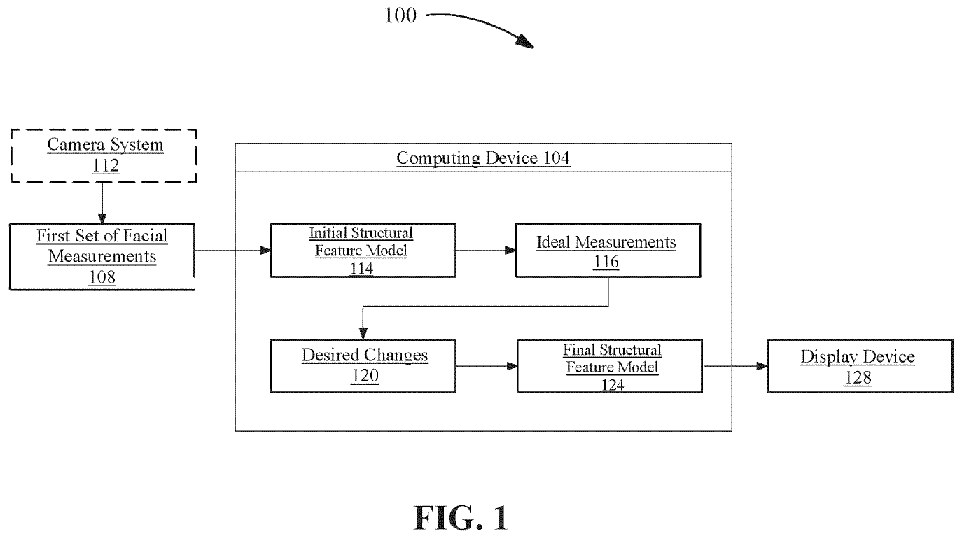

Referring now to FIG. 1, an exemplary embodiment of an apparatus for automated smile design modeling 100 is illustrated. In an embodiment, an apparatus for automated smile design modeling 100 may be configured to capture a first set of facial measurements 108 via a camera system 112. As used in this disclosure, a “first set of facial measurements” is a set of measurements of a patient's face and dental structure gathered at one or more appointments. First set of facial measurements 108 may include specific measurements and/or scans, such as without limitation facial or dental scans, obtained from any embodiment of camera system 112, as described below within this disclosure. In an embodiment, specific measurements may include central incisor length (CIL), incisal display at rest, overbite, overjet, gingival display, incisal display at full smile including gums, lower incisal edge to commissure, interlabial gap with lips at rest, incisal edge to wet-dry line full smile (IEWDL), and incisal edge from vertical (IFV). Additional exemplary specific measurements may include, but are not limited to, measurements associated with, smile arc, buccal corridor, gingival display, canine and posterior crown torque, ideal and large corridor, maxillary midline to face, maxillary to mandibular midline, maxillary ventral incisor gingival height discrepancy, maxillary lateral incisor gingival height discrepancy, maxillary central-to-lateral incisal ratio, and occlusal cant. In some embodiments a first set of facial measurements 108 may require additional measurements to be taken, for example, but without limitation, if the measurements are inaccurate or missing.

With continued reference to FIG. 1, Camera system 112 may include one or more cameras, scanners, digitizers, and the like. In some embodiments, camera system 112 may include an optical camera, such as a digital single-lens reflex (SLR) camera, three-dimensional facial scanner, and/or a three-dimensional dental scanner, including digital intraoral scanners and/or extraoral scanners. As used in this disclosure, a “camera” is a device that is configured to sense electromagnetic radiation, such as without limitation visible light, and generate an image representing the electromagnetic radiation. In some cases, a camera may include one or more optics. Exemplary non-limiting optics include spherical lenses, aspherical lenses, reflectors, polarizers, filters, windows, aperture stops, and the like. In some cases, at least a camera may include an image sensor. Exemplary non-limiting image sensors include digital image sensors, such as without limitation charge-coupled device (CCD) sensors and complimentary metal-oxide-semiconductor (CMOS) sensors, chemical image sensors, and analog image sensors, such as without limitation film. In some cases, a camera may be sensitive within a non-visible range of electromagnetic radiation, such as without limitation infrared. As used in this disclosure, “image data” is information representing at least a physical scene, space, and/or object. In some cases, image data may be generated by a camera. “Image data” may be used interchangeably through this disclosure with “image,” where image is used as a noun. An image may be optical, such as without limitation where at least an optic is used to generate an image of an object. An image may be material, such as without limitation when film is used to capture an image. Additionally, an image may be digital, such as without limitation when represented as a bitmap. Alternatively, an image may be comprised of any media capable of representing a physical scene, space, and/or object. Where “image” is used as a verb, in this disclosure, it refers to generation and/or formation of an image. A scanner, in an embodiment, may include light scanners, laser scanners, and/or contact scanners.

Still referring to FIG. 1, camera system 112 may capture a first set of facial measurements 108 directly through images, scans including but not limited to 2D and/or 3D intraoral scans, face scans, physician measurements by hand or the like, of a patient, or they may capture a first set of measurements from a dental mold previously taken of said patient. A “dental mold” as used in this disclosure, is a model of a patient's teeth created by taking an impression of said patient's teeth. In some embodiments, a first set of facial measurements 108 may be taken in accordance with procedures aligned with photogrammetry. As used within this disclosure, “photogrammetry” is the art and science of extracting three-dimensional information from photographs. The process may involve taking overlapping photographs of an object, structure, or space, and converting them into two-dimensional and three-dimensional models. Alternatively, a first set of facial measurements 108 may be obtained through three-dimensional facial scanners and/or three-dimensional dental scanners that are configured to create a three-dimensional model from said scans.

With further reference to FIG. 1, an apparatus for automated smile design modeling 100 may be further configured to generate a structural feature model. As used in this disclosure, “structural feature model” is a model of a patient's entire facial structure, including without limitation, jaw and lip placement, bite, and other dental parameters including any embodiment of at least a first set of facial measurements 108 as described above. Generation of a structural feature model may include generating an initial structural feature model 114 using at least a first set of facial measurements 108; identifying a plurality of ideal measurements 116, which may be identified using a data structure representing at least a stored rule that associates the first set of facial measurements 108 with the ideal measurements 116; determining a plurality of desired changes 120, which may be identified using at least a second set of stored rules that matches the first set of facial measurements 108 and ideal measurements 116 to transformations to achieve ideal measurements 116; and applying said desired changes 120 to the structural feature model, generating a final structural feature model. An “initial structural feature model,” as used in this disclosure, is a base structural feature model generated using the at least a first set of facial measurements 108 captured by camera system 112. The initial structural feature model 114 acts as an exact two-dimensional and/or three-dimensional replica of the patient's facial and/or dental features and provides a canvas to make the changes necessary to reach an ideal or “perfect” smile. The initial structural feature model 114 and/or final structural feature model 124 may be digital and/or a wax-up. A “wax-up,” as used in this disclosure, is a wax and/or resin pattern contoured to the desired form for a trial denture, cast coping, metal framework, or for diagnostic purposes. As used in this disclosure, “ideal measurements” relate to the measurements associated with an “ideal smile,” which illustrates a balanced and appropriate positioning of the teeth and gingival scaffold within the dynamic display zone. Because there is no one true “perfect” smile even automated processes, such as these, may allow for user input. Therefore, following the generation and display of a final structural feature model 124 the process may also include obtaining user data corresponding to the structural feature model and changes based on a user's preference, which may then be applied to the final structural feature model 124. As used in this disclosure, “at least a stored rule” is a data structure that defines and/or correlates relationships between individual facial measurements and ideal measurements 116. At least a stored rule may include an individual rule and/or a combination of one or more rules. Additionally, “a second set of stored rules,” as described in this disclosure is one or more rules that define and/or correlate relationships of a first set of facial measurements 108 and ideal measurements 116 with the matched transformation and or transformations required to achieve an ideal measurement. “Transformation,” as used in this disclosure is any individual change or combination of changes made to a first set of facial measurements 108 to obtain an ideal measurement.

With continued reference to FIG. 1, in some embodiments an apparatus for automated smile design modeling 100 may instantiate a machine-learning model. This model may be configured to receive at least a first set of facial measurements 108 and output a final structural feature model 124 with ideal measurements 116. Instantiating a machine learning model may function to improve efficiency and capabilities of an apparatus for automated smile design. A first set of facial measurements 108 may be received from any embodiment of camera system 112 as described in this disclosure. Additionally, even in this embodiment, desired changes 120 may be made through the input of the user as described within this disclosure.

Still referring to FIG. 1, in some embodiments, an apparatus for automated smile design modeling 100 may instantiate a neural network. This model may be configured to receive at least a first set of facial measurements 108 and output a structural feature model with ideal changes. In some embodiments, instantiating a neural network model may function to require less formal statistical training than other processes. A first set of facial measurements 108 may be received from any embodiment of camera system 112 as described in this disclosure. Additionally, even in this embodiment, desired changes 120 may be made through the input of the user as described within this disclosure.

Still referring to FIG. 1, apparatus for automated smile design modeling may identify ideal measurements 116 based on one or more stored rules. In an embodiment, stored rules may include an arithmetic and logical instruction set, which may be accessible to apparatus for automated smile design modeling to complete transformation of a first set of measurements, generating changes necessary to apply and generate a final structural feature model 124. Using one or more stored rules and relationships described within this disclosure, apparatus for automated smile design modeling may perform tasks it was unable to perform before, specifically modeling structural changes automatically. This at least one or more rules may permit apparatus for automated smile design modeling to emulate the human artistic process of smile design. As used in this disclosure, the “human artistic process of smile design” is the process by which a human artist applies their creative and/or logical design rules to a particular patient's smile to create the ideal smile model for that individual patient. A “human artist” in this instance may be, without limitation, any person, artist, or design technician, that applies the manual process of smile design to an individual patient's measurements. In an embodiment, one or more stored rules may correlate to the following measurements: central incisor length (CIL), incisal display at rest, overbite, overjet, gingival display (full smile), incisal display at full smile including gums (FSD), lower incisal edge to commissure, interlabial gap with lips at rest, incisal edge to wet-dry line full smile (IEWDL), and incisal edge from vertical (IFV). More specifically, in some embodiments specific stored rules may include minimums and maximums regarding position, length, and/or level change. Exemplary rules may include relationships for incisal length change, horizontal incisal edge position change, gingival level change, overall tooth length, new overbite/overjet (OB/OJ), vertical dimension of inclusion.

Still referring to FIG. 1, stored rules are not limited to a definite set of parameters but rather an indefinite, and growing set of parameters interpreted from a plurality of data sources. For example, a plurality of stored rules may correlate a plurality of measurements based on associations identified in and/or extracted from medical, dental, experimental, literatures/research material, and the like. Generating the stored rules may include using a web crawler to parse a plurality of online data sources for relevant information regarding the measurements as described above. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. The web crawler may be seeded and/or trained with a reputable website to begin the search. A web crawler may be generated by a computing device 104. In some embodiments, the web crawler may be trained with information received from a user through a user interface. In some embodiments, the web crawler may be configured to generate a web query. A web query may include search criteria received from a user. For example, a user input may program the web crawler to parse/analyze resources defending an atypical lengthening of teeth to 15 mm to a correct smile instead of the average length of 11 mm. Using such atypical data may configure the stored rules to be based on correlations between measurements not commonly known or practiced within dentistry. Computing device may identify data pattern among the data sources/data received from the web crawler using any machine-learning algorithm as described in this disclosure. For example, a K-Means Clustering algorithm may be used to group similar data points supporting atypical measurements in creating a perfect smile.

Still referring to FIG. 1, the stored rules may be used to identify applicable ranges for altering a smile. For example, an Incisal Length Change Rule may indicate the following parameters: a minimum added length ranging from 0.5 millimeters (mm) to 1 mm; a maximum added length ranging from 2 mm to 5 mm; an ideal change range of 0.75 mm to 3.5 mm, with the average change length being 2.125 mm; and the length change must be subtracted from incisal display at rest (RD) and RD must not fall below 2 mm. A Horizontal Incisal Edge Position Change Rule may indicate the following parameters: a minimum horizontal movement of 1 mm; a maximum horizontal movement of 3 mm; an average horizontal movement of 2 mm; a maximum movement based on inclination of 2 mm; a maximum movement based on OB/OJ of 3 mm; a minimum movement based on OB of 1 mm; an ideal horizontal change of 1.75 mm; and a build out of buccal contour of 1.75 mm. A Gingival Level Change Rule may indicate the following parameters: a maximum CIL of 1.5 mm; a minimum CIL of −0.5 mm; with an average of 0.5 mm; and if negative then extrusion needed. An Overall Tooth Length Rule may indicate the following parameters: a maximum of 14.5 mm; a minimum of 9.75 mm; and perfect overall tooth length of 12.125 mm. A New OB/OJ Vertical Rule may indicate the following parameters: a new OB of 6.125 mm; a new OJ of 3.75 mm; if OB>5 mm, then open vertical needed; if a vertical increase needed new OB minus 4>1; if vertical increase occurs OJ increase may be necessary, if vertical increase >2 mm then need a second arch or at least ten teeth. Stored rules may be adjusted and implemented by machine learning as described within this disclosure.

Still referring to FIG. 1, apparatus for automated smile design modeling 100 may transform a first set of facial measurements 108 using a second set of stored rules. Desired changes 120 may be identified by matching the correlated first set of facial measurements 108 and ideal measurements to transformations. Transformations may include up to eight changes indicated in the feature structural model in accordance with the first set of measurements. These eight changes may include: incisal length change, horizontal incisal length change, horizontal cervical height of curvature (HOC) change, gingival level change, overall tooth length, new overbite OB, new OJ, and/or change in vertical dimension of occlusion (VDO). Transformation may occur locally and/or on a remote device and then transmitted to apparatus for automating smile design modeling. In either embodiment, additional desired changes 120 may be made by way of user input to the model as described within this disclosure.

With further reference to FIG. 1, in an embodiment, apparatus for automated smile design modeling 100 may improve and/or fine tune the application of a stored rules and/or a second set of stored rules using aggregations, instantiating a machine-learning model, and/or instantiating a neural network. Training data that may be used to train the machine-learning model and/or the neural network may include exemplary input data, such as without limitation, stored rules, a second set of stored rules, first set of facial measurements 108, initial structural feature model 114, final structural feature model 124, and/or demographics of patient such as; age, nationality, ethnicity, geographical location, and the like, where each such example may be correlated to additional exemplary output data such as, without limitation, final structural feature model with ideal measurements 116, relationships between a facial/dental measurement and a transformation, and desired changes 120, and/or predictions of desired changes 120 based on demographics of patient. Training of the model/network may take place either at the apparatus for automated smile design modeling 100 or remotely; in the latter case, the model/network may be deployed at or by apparatus for automated smile design modeling 100 in any manner as described within this disclosure. Additionally, in some embodiments, the machine-learning model and/or the neural network may be updated to apparatus for automated smile design modeling 100, the model/network may be deployed at or by apparatus for automated smile design modeling 100 in any manner as described in this disclosure. The machine-learning model and/or neural network may be deployed/instantiated once trained in any form as described within this disclosure. Feedback from the deployment of the machine-learning model and/or neural network may be turned into new training data, which may be stored either locally and/or transmitted to another device and used for retraining of the model/network. Retraining may be administered either remotely or at apparatus for automated smile design modeling 100. Following the retraining of the model/network, redeployment/instantiation may be accomplished at or by apparatus for automated smile design modeling 100 in any manner as described within this disclosure.

Still referring to FIG. 1, stored rules may be broadly categorized into aesthetic and functional changes, each targeting specific aspects of smile optimization. Aesthetic changes focus on the visual appeal of the smile, adjusting features such as incisal length, gingival display, and the horizontal position of the incisal edge. These adjustments enhance the harmony and balance of the teeth within the overall facial structure, aiming to improve the outward appearance of the smile. Functional changes, on the other hand, address the biomechanics of the smile, including overbite, overjet, and vertical dimension of occlusion. These changes ensure that the smile is not only visually appealing but also mechanically sound, facilitating better chewing function and long-term oral health. By categorizing the stored rules into these two areas, apparatus for automated smile design modeling 100 can systematically apply the necessary transformations to achieve an ideal smile, determining which changes to prioritize based on the specific needs and desired outcomes for each patient. This structured approach helps in delivering personalized results that blend both aesthetic appeal and functional integrity, ultimately crafting smiles that are both beautiful and effective.

Still referring to FIG. 1, an apparatus for automated smile design modeling 100 may include a machine-learning model configured to identify and output recommended dental procedures based on first set of facial measurements 108 and/or ideal measurements 116. A “dental procedure,” as used herein, is a task, treatment, or intervention performed by a dentist or dental healthcare professional to address a dental issue, maintain oral health, or improve the aesthetic appearance of the teeth and surrounding structures. A dental procedure may include aligner therapy, veneers, crowns, or jaw surgery, and the like. Training may be received using similar methods as described above, for example, using a WebCrawler to gather facial measurements correlated to specific types of dental procedures. The training data may include a plurality of facial measurements and/or ideal measurements correlated to a plurality of dental procedures.

With further reference to FIG. 1, an apparatus for automated smile design modeling 100 100 may be configured to undergo image processing. As used in this disclosure, “image processing” is a process or series of processes applied to at least a captured image, that acts to improve, restore, analyze, or in some way change a digital image. Phases associated with image processing may include image acquisition, image enhancement, image restoration, color image processing, wavelets and multi-resolution processing, image compression, morphological processing, image segmentation, representation and description, and/or object detection and recognition. Image processing may include certain phases as disclosed above, or more generally fit into five categories: image restoration, image enhancement, image analysis, image synthesis, and image compression. An apparatus for automated smile design modeling 100 may be configured to locally undergo one or more of the image processing phases/categories as described above and/or be transmitted the processed image from a remote device, such as without limitation, camera system 112. Namely, apparatus for automated smile design modeling 100 may be configured to undergo image restoration of a first set of facial measurements 108 captured by camera system 112. “Image restoration” as used within this disclosure refers to preprocessing steps performed to correct an image for known defects and to adjust the image intensities so that they are suitable for viewing. Additionally, apparatus for automated smile design modeling 100 may be configured to undergo image enhancement. As used in this disclosure, “image enhancement” are operations applied to make an image visually more appealing, such as without limitation, increasing contrast, optimizing brightness, increasing sharpness, and/or reducing noise. apparatus for automated smile design modeling 100 may also be configured to undergo image analysis. “Image analysis” as used in this disclosure described the process of extracting specific information from an image, such as without limitation, simple linear measurements, and/or fully automated diagnosis. Within image analysis a multitude of processes may be performed; apparatus for automated smile design modeling 100 may be configured to extract data from images using one or more of the following processes without limitation, measurement, segmentation, properties finding, and/or object classification. Apparatus for automated smile design modeling 100 may additionally be configured to undergo image synthesis. As used in this disclosure, “image synthesis” is the creation of a new image and the process by which a three-dimensional display of the interested object is accomplished. For example, and without limitation, image synthesis may be used to create the structural feature model incorporating the first set of measurements and ideal changes associated with set stored rules as discussed within this disclosure. Lastly, apparatus for automated smile design modeling 100 may be configured to undergo image compression. Within this disclosure, “image compression” is the reduction in size of a digital image, the purpose of which is for casing or making more efficient the archiving or transmission of the image. Images may be compressed by a variety of methods including, but not limited to lossless methods and/or lossy methods. “Lossless methods” refers to methods of image compression that do not discard any image data and produce an exact copy of the image after decompression. Alternatively, “lossy methods” refers to methods of image compression that achieve higher levels of compression by discarding image data. Joint Photographic Experts Group (JPEG) provides a range of compression levels and was adopted as the standard compression level by Version 3.0 of the Digital Imaging and Communications in Medicine (DICOM). A computing device may undergo any method of image compression as described within this disclosure.

Still referring to FIG. 1, in some embodiments, apparatus for automated smile design modeling 100 may include a machine vision system that includes camera system 112. A machine vision system may use images from camera system 112, to make a determination about a scene, space, and/or object. For example, in some cases a machine vision system may be used for world modeling or registration of objects within a space. In some cases, registration may include image processing, such as without limitation object recognition, feature detection, edge/corner detection, and the like. Non-limiting examples of feature detection may include scale invariant feature transform (SIFT), Canny edge detection, Shi Tomasi corner detection, and the like. In some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ø may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level. In some cases, a machine vision system may use a classifier, such as any classifier described throughout this disclosure.

Continuing to reference FIG. 1, an exemplary embodiment of machine vision may implement image analysis by way of image segmentation as a preprocess for object detection/classification. Image segmentation tasks may be classified into three groups based on the amount and type of information they convey: semantic segmentation, instance segmentation, and/or panoptic segmentation. Apparatus for automated smile design modeling 100 may implement one or any combination of image segmentation methods, as described within this disclosure. Traditional image segmentation implements digital image processing coupled with optimization algorithms, which make use of methods such as without limitation, region growing and snakes algorithm. These methods take a local view of the features in an image and focus on local differences and gradients in pixels. More modern image segmentation methods take a global view of the input image and implement methods such as, but without limitation, adaptive thresholding, Otsu's algorithm, and clustering algorithms. Threshold methods may include, without limitation, Otsu's algorithm and/or a mean shift method. Whereas, region-based methods may include, but are not limited to, region growing and/or region split and merge methods. Additionally, edge-based methods may include without limitation, Canny, gradient, and/or Laplacian methods. Watershed based methods may include, but are not limited to, watershed and/or marker-controlled watershed methods. Alternatively, clustering-based methods may include without limitation, K means, and/or Fuzzy C-means methods. Deep learning-based methods of image segmentation may also be implemented by apparatus for automated smile design modeling 100. Embodiments of deep learning-based methods may include semantic segmentation models, such as without limitation, methods containing convolutional encoder-decoder architecture; convolutional encoder-decoder and/or U-Net. Any of the described image segmentation processes may be used to classify images as captured by a first set of measurements. Classifications may be made of the underlying dental and facial structures in order to create a structural facial model labeled with said classifications. Exemplary classifications may include, without limitation, lips, teeth, gums, jaw, and any other facial feature captured by first set of measurements.

With further reference to FIG. 1, in an embodiment, apparatus for automated smile design modeling 100 may undergo image processing, specifically segmentation and object classification using aggregations, instantiating a machine-learning model, and/or instantiating a neural network. Training data that may be used to train the machine-learning model and/or the neural network may include exemplary input data, such as without limitation, two-dimensional images and/or three-dimensional images, where each such example may be correlated to additional exemplary output data such as, without limitation, encoded images with semantic labels. Training of the model/network may take place either at the apparatus for automated smile design modeling 100 or remotely; in the latter case, the model/network may be deployed at or by apparatus for automated smile design modeling 100 in any manner as described within this disclosure. Additionally, in some embodiments, the machine-learning model and/or the neural network may be updated to apparatus for automated smile design modeling 100, the model/network may be deployed at or by a computing device in any manner as described in this disclosure. The machine-learning model and/or neural network may be deployed/instantiated once trained in any form as described within this disclosure. Feedback from the deployment of the machine-learning model and/or neural network may be turned into new training data, which may be stored either locally and/or transmitted to another device and used for retraining of the model/network. Retraining may be administered either remotely or at apparatus for automated smile design modeling 100. Following the retraining of the model/network, redeployment/instantiation may be accomplished at or by apparatus for automated smile design modeling 100 in any manner as described within this disclosure.

With further reference to FIG. 1, an exemplary embodiment of image processing may include photogrammetry. Image processing may occur on any embodiment of an apparatus for automated smile design modeling 100 as described within and/or remotely as previously disclosed. As described above, “photogrammetry” is the art and science of extracting three-dimensional information from photographs. This may be accomplished by taking overlapping photos of an object, structure, or space, and converting them into two-dimensional and three-dimensional models. Each point in an image may define a light ray in three-dimensional space that starts at the camera and extends out to the real point. “Real point” as used in this disclosure, is the point in the physical world of any object in an image. Additional information may be required, such as without limitation, the position and angle of camera system 112 for each captured image and camera system's ##characteristics, such as without limitation, focal length, pixel size, and lens distortion. Once the previous data is accumulated, the geometric intersection of the light rays may be calculated and determine the location of individual points in three-dimensional space. Triangulation of these points assists in determining the overall three-dimensional model. As used in this disclosure, “triangulation” refers to the method of using multiple photos for solving points through point matching and ray intersection. “Point matching” is finding two or more points on an image that correspond to the same three-dimensional location and can be done manually or automatically. Additionally, “ray intersection” as used in this disclosure, is when the light rays meet. The result of this may create lines, surfaces, texture-maps, and/or full three-dimensional models, such as a facially structural model. Some embodiments of photogrammetry may be capable of determining certain metrics based on a single image if dimensional metrics are known about other structures in the image. For example, and without limitation the height of incisal display may be determined from a single image if metrics of other facial features are known to the system.

With further reference to FIG. 1, in an embodiment, apparatus for automated smile design modeling 100 may process images using photogrammetry using aggregations, instantiating a machine-learning model, and/or instantiating a neural network. Training data that may be used to train the machine-learning model and/or the neural network may include exemplary input data, such as without limitation, set stored rules, measurements of facial and/or dental structures, dimensions of facial and/or dental structures, two-dimensional images, three-dimensional images, position and/or angle of camera for each image, and/or camera system 112 characteristics, such as without limitation, focal length, pixel size, and/or lens distortion, where each such example may be correlated to additional exemplary output data such as, without limitation, geometric intersection of light rays, location of individual points in three-dimensional space, triangulation measurements, point matching data, ray intersection data, three-dimensional model. Training of the model/network may take place either at the apparatus for automated smile design modeling 100 or remotely; in the latter case, the model/network may be deployed at or by apparatus for automated smile design modeling 100 in any manner as described within this disclosure. Additionally, in some embodiments, the machine-learning model and/or the neural network may be updated to apparatus for automated smile design modeling 100, the model/network may be deployed at or by apparatus for automated smile design modeling 100 in any manner as described in this disclosure. The machine-learning model and/or neural network may be deployed/instantiated once trained in any form as described within this disclosure. Feedback from the deployment of the machine-learning model and/or neural network may be turned into new training data, which may be stored either locally and/or transmitted to another device and used for retraining of the model/network. Retraining may be administered either remotely or at apparatus for automated smile design modeling 100. Following the retraining of the model/network, redeployment/instantiation may be accomplished at or by apparatus for automated smile design modeling 100 in any manner as described within this disclosure.

With further reference to FIG. 1, in some embodiments, an apparatus for automated smile design modeling 100 may assist existing computer-aided design (CAD) systems with transformation. As used in this disclosure, “existing CAD systems” is in reference to CAD systems that exist apart from apparatus for automated smile design modeling 100. CAD systems refer to technology for design and technical documentation, which replaces manual drafting with an automated process. CAD systems are used to increase the productivity of the designer, improve the quality of design, improve communications through documentation, and to create a database for manufacturing. Transformation as described in this disclosure may aid current CAD systems by providing an automated solution to a currently manual process. By implementing the stored rules and relationships as described within this disclosure CAD systems will have the necessary information to complete transformation of a first set of measurements. Generally, CAD systems follow a process in which: scans and/or images are obtained; extraction of dimensional information, such as without limitation, geometries, dimensions, and cross-sections occurs; models are input into CAD software and CAD modeling commences; a comparison of the CAD model and the initial model input is made; analysis of the CAD model is undergone and the comparison is used to optimize the initial input model; and the final CAD model is exported for manufacturing. Implementation of automated smile design and modeling transformation may eliminate the need for manual processing of the initial model input. Consequently, the entire process from start to finish may be optimized by providing an entirely automated process.

A person rendering a future smile without benefit of automation would use subjective assessment of the aesthetics of a face with teeth repositioned to determine a degree to which one or more elements of teeth, palate, or the like should be repositioned. In contrast, methods and apparatuses described in this disclosure permit a computing device or similar apparatus to automate selection of an aesthetically beneficial change by using stored rules for the above eight transformations as described in this disclosure. Use of stored rules may permit a computing device to determine transformations that simulate and/or automate aesthetically selected choices using procedures that are distinct from those employed by human professionals; stored rules permit computing devices to automate this process in a manner that was not possible for computing devices prior to the disclosed invention, obviating the need for human intervention. In an embodiment, stored rules may be limited to a set of specific characteristics, such as rules governing use of above-described eight measurements.

Still referring to FIG. 1, in some embodiments, an apparatus for automated smile design modeling 100 may include a computing device 104. Computing device 104 includes a processor communicatively connected to a memory. As used in this disclosure, “communicatively connected” means connected by way of a connection, attachment, or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Further referring to FIG. 1, computing device 104 may include any computing device 104 as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently, or may include two or more computing devices 104 operating in concert, in parallel, sequentially or the like; two or more computing devices 104 may be included together in a single computing device 104 or in two or more computing devices 104. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices 104, and any combinations thereof. A network may employ a wired and/or a wireless mode of communication. In general, any network topology may be used. Information (e.g., data, software etc.) may be communicated to and/or from a computer and/or a computing device 104. Computing device 104 may include but is not limited to, for example, a computing device 104 or cluster of computing devices 104 in a first location and a second computing device 104 or cluster of computing devices 104 in a second location. Computing device 104 may include one or more computing devices 104 dedicated to data storage, security, distribution of traffic for load balancing, and the like. Computing device 104 may distribute one or more computing tasks as described below across a plurality of computing devices 104 of computing device 104, which may operate in parallel, in series, redundantly, or in any other manner used for distribution of tasks or memory between computing devices 104. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, apparatus for automatic smile design modeling may be configured to display a final structural feature model 124 on a display device 128. A “display device,” as used in this disclosure is a device for visual or tactile presentation of images, videos, and/or text acquired, stored, or transmitted in various forms. Display device 128 may allow a user to visually see the structural feature model. A display device 128 may also be configured to allow for manipulation of the final structural figure model. Exemplary embodiments of a display device 128 may include computer monitors, TV screens, 2D scanners, 3D scanners, and/or the like.

With continued reference to FIG. 1, display device 128 may support a graphical user interface (GUI). A “graphical user interface” as used in this disclosure is a digital interface in which a user interacts with graphical components such as, without limitation, a pointer, icons, windows, scroll bars, buttons, and menus. The visuals displayed on the GUI may convey information relevant to the user, as well as actions that they can take. In some embodiments, the GUI may provide a graphics visual that exhibits, without limitation, a mouse cursor, which moves and manipulates other elements, buttons, which users may click or tap to initiate an action, toolbar and ribbons, icons, which may represent various information or interactive components, menus, and/or scrollbars. An exemplary embodiment may include: a menu bar, which may include saving options and interface options; an options bar, which may change depending on what tool is selected and contains greater control over elements like measurements and text; a tool bar, which may be used to interact with and add to the document; one or more panels, which may provide a way to access important tools and settings quickly, these may be organized into tabs, and/or opened from multiple bars/ribbons throughout interface; one or more model windows, which is where the model design will take place, this may additionally display a ruler and/or guidelines not visible in a final draft; and a canvas, where edits to the model will take place. In some embodiments, one or more model windows may be open at a time and displayed on the GUI in an icon, which may allow the user to navigate between versions of the document. Additionally, the first set of measurements may be modeled in a layer that can be viewed concurrently with any ideal measurements 116 or desired changes 120. This embodiment may allow a user to view the changes made over the course of the automated design and may be done in layers or in a side-by-side comparison. “Layers” in this case refer to windows depicting a said model, layering of which allows the two windows to be viewed in overlap of one another. In this embodiment one layer may be more translucent in order to facilitate a productive comparison of the changes made. In some embodiments, changes to the structural feature model may occur following transformation of the model and may occur in more than one instance of change. An exemplary, but non-limiting interactive display, may include interactive input options able to control metrics associated with the first set of measurements as discussed in this disclosure as well as additional parameters associated with a dental treatment plan, such as without limitation teeth color or brightness. This may be accomplished by providing interactive text displays and/or arrows allowing a user to toggle between numerical values, which will adjust the model displayed. A save option may be available and allow the user to create multiple panels, each of which may hold a saved version of the model. Additionally, this interface may provide an undue and/or redo option, allowing the user to toggle forward and backward through their applied changes. In some embodiments, the GUI may provide for a section that displays suggestions based on ideal measurements 116 and demographic data of the patient.

With continued reference to FIG. 1, apparatus for automated smile design modeling 100 may be configured to produce a transformation treatment report. A “transformation treatment report,” as used in this disclosure, is a report that describes potential treatment options to obtain the changes in a final structural feature model 124. Transformation treatment report may describe needed changes and modalities identifying suggestions and/or limitations and timeframes of each. An automated design of one or more changes may be outputted onto a screen, 2D scanner, 3D scanner, and/or milling machine in the form of a dental model of desired results or dental prosthesis such as veneers or crowns. Treatments may be staged to match ideal models including orthognathic surgery guidelines and animation of tooth movement for fabrication of aligners. In some instances, this may be performed using a machine learning process, including any machine learning process as described herein. Potential treatment options may be related to any of the measurements taken as described within this disclosure. Additionally, treatment options may include, but are not limited to orthodontic treatment, aligner therapy, veneers, other dental implants, crowns, bridges, jaw surgery, and/or the like. In addition to describing potential treatment options, a computing device may be configured to describe the limitations within each treatment modality and suggest the best course of action for any particular patient. A transformation treatment report may be generated by taking the values of change based on the comparison of a final structural feature model 124 to a corresponding first set of measurements. In some instances, final structural feature model 124 may be output to a 3D printer and/or mill for facial and/or dental models for ideal modeling of dental prosthesis such as veneers and/or crowns. These values of change may inform a computing device of treatment options and limitations available to be implemented into a transformation treatment report by applying said values of change to set stored treatment rules. Exemplary set stored treatment rules may include relationships between certain values of change, such as without limitation: incisal length change, horizontal incisal edge change, horizontal cervical HOC change, gingival level change, overall tooth length change, new OB, new OJ, and/or change in VDO, and specific treatments and/or combinations of treatments as described above. Treatments may be associated with one or more of the changes as listed. Exemplary treatments may include the placement of crowns, which may be done to protect one or more teeth that have become weak and/or broken. Additional exemplary treatments may include aligner therapy, which may be initiated to create movement of one or more teeth. Continued exemplary treatments may include the placement of veneers, which may be implemented to treat stained, chipped, crooked, damaged teeth and/or conceal uneven spaces between one or more teeth. Additionally, and without limitation, exemplary treatments may include jaw surgery, which may be undergone to correct irregularities of the jawbone and may realign jaw and teeth to improve function and facial esthetic. One or more of these treatments may be undergone to produce the most desirable outcome. Storage of the set stored treatment rules may be stored locally, or remotely in any form as discussed within this disclosure. The transformation treatment report may be made available, without limitation on the GUI as described above, as a text file, as a text file containing images, as a portable document format (PDF), and/or the like.

With further reference to FIG. 1, in an embodiment, apparatus for automated smile design modeling 100 may produce a transformation treatment report using aggregations, instantiating a machine-learning model, and/or instantiating a neural network. Training data that may be used to train the machine-learning model and/or the neural network may include exemplary input data, such as without limitation, set stored treatment rules, first set of measurements, structural feature model, final structural feature model 124, and/or treatment options, such as without limitation, aligner therapy, veneers, crowns, jaw surgery, and/or the like, where each such example may be correlated to additional exemplary output data such as, without limitation, final structural facial model with ideal measurements 116 and desired changes 120, and/or treatment options, such as without limitation aligner therapy, braces, veneers, other dental implants, crowns, bridges, jaw surgery, and/or the like. Training of the model/network may take place either at the apparatus for automated smile design modeling 100 or remotely; in the latter case, the model/network may be deployed at or by apparatus for automated smile design modeling 100 in any manner as described within this disclosure. Additionally, in some embodiments, the machine-learning model and/or the neural network may be updated to apparatus for automated smile design modeling 100, the model/network may be deployed at or by apparatus for automated smile design modeling 100 in any manner as described in this disclosure. The machine-learning model and/or neural network may be deployed/instantiated once trained in any form as described within this disclosure. Feedback from the deployment of the machine-learning model and/or neural network may be turned into new training data, which may be stored either locally and/or transmitted to another device and used for retraining of the model/network. Retraining may be administered either remotely or at apparatus for automated smile design modeling 100. Following the retraining of the model/network, redeployment/instantiation may be accomplished at or by apparatus for automated smile design modeling 100 in any manner as described within this disclosure.

Still referring to FIG. 1, in some embodiments the transformation treatment report may additionally include recommended duration data for implementing a procedure. For example, a duration machine learning model may be implanted to receive first set of facial measurements 108, initial structural feature model 104, ideal measurement 116, desired changes 120, and/or final structural feature model 124 as inputs and output a duration data matched to a transformation procedure as described above. “Duration data,” is information referring to the duration of a treatment or procedure. For example, duration data may include timeline for implementing braces, when to adjust braces, the speed at which teeth shift and the like. The duration machine learning model may be trained on a split of historical data on how long these treatments have historically taken correlate to the inputs as described above, using cross-validation to ensure robustness. Model performance may be evaluated using metrics such as Mean Absolute Error and Root Mean Squared Error, fine-tuning parameters and features based on these outcomes. Once optimized, the duration machine learning model may be deployed into a clinical setting, integrated into the planning process through a graphical user interface that allows orthodontists to access predicted treatment durations as they design treatment protocols. This deployment may include ongoing monitoring and updates with new data to maintain the model's accuracy and relevance, enhancing both clinical decision-making and patient care efficiency.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

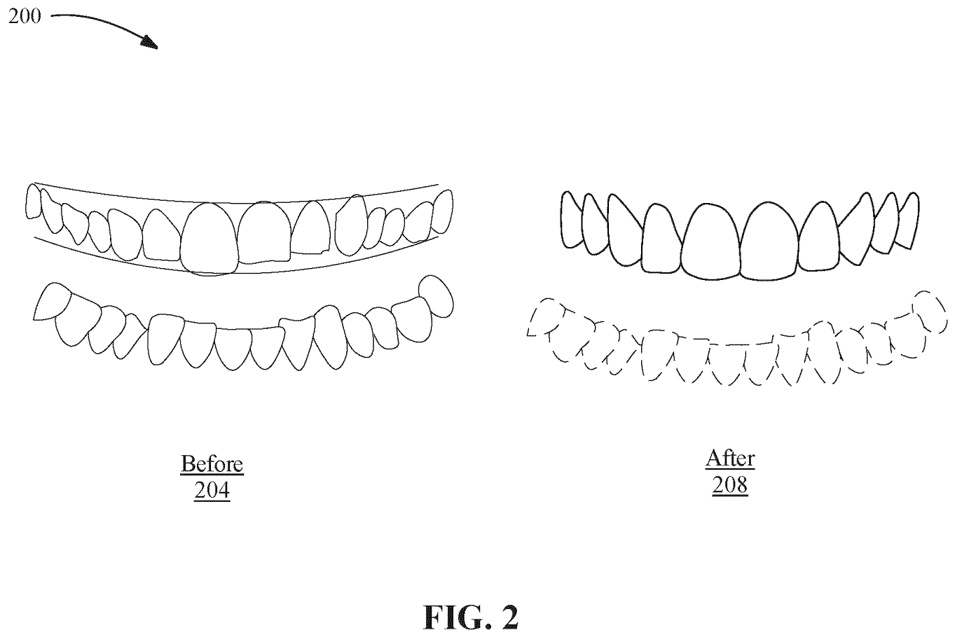

Referring now to FIG. 2, a before and after depiction of a client who implemented a recommended treatment plan produced by apparatus for automatic smile design modeling is presenting an exemplary implementation of automated smile design modeling. Before depiction 204 is pictured and illustrates a client's dental structure prior to their treatment. Whereas, after depiction 208 illustrates the client's dental structure after undergoing their personalized treatment plan. In some embodiments treatment is only applied to certain focal areas of the dental structure. Alternatively, in some embodiments, a treatment plan will widen its treatment and apply changes to the dental structure in its entirety. The treatment produces a perfect smile that is ageless and creates a new confidence in clients.

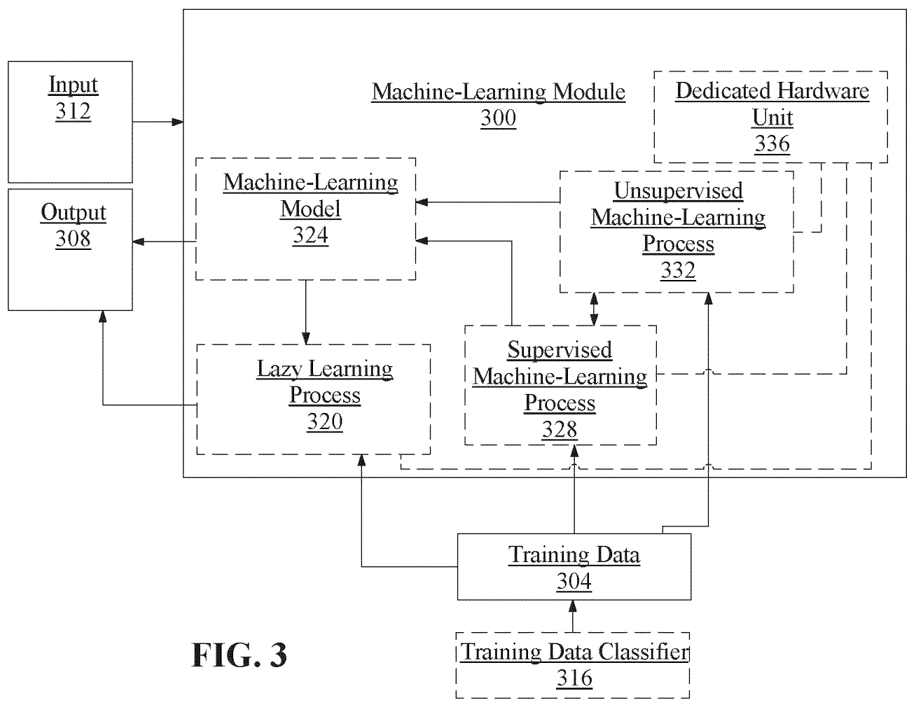

Referring now to FIG. 3, an exemplary embodiment of a machine-learning module 300 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 304 to generate an algorithm instantiated in hardware or software logic, data structures, and/or functions that will be performed by a computing device/module to produce outputs 308 given data provided as inputs 312; this is in contrast to a non-machine learning software program where the commands to be executed are determined in advance by a user and written in a programming language.

Still referring to FIG. 3, “training data,” as used herein, is data containing correlations that a machine-learning process may use to model relationships between two or more categories of data elements. For instance, and without limitation, training data 304 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 304 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 304 according to various correlations; correlations may indicate causative and/or predictive links between categories of data elements, which may be modeled as relationships such as mathematical relationships by machine-learning processes as described in further detail below. Training data 304 may be formatted and/or organized by categories of data elements, for instance by associating data elements with one or more descriptors corresponding to categories of data elements. As a non-limiting example, training data 304 may include data entered in standardized forms by persons or processes, such that entry of a given data element in a given field in a form may be mapped to one or more descriptors of categories. Elements in training data 304 may be linked to descriptors of categories by tags, tokens, or other data elements; for instance, and without limitation, training data 304 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 3, training data 304 may include one or more elements that are not categorized; that is, training data 304 may not be formatted or contain descriptors for some elements of data. Machine-learning algorithms and/or other processes may sort training data 304 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 304 to be made applicable for two or more distinct machine-learning algorithms as described in further detail below. Training data 304 used by machine-learning module 300 may correlate any input data as described in this disclosure to any output data as described in this disclosure. As a non-limiting illustrative example, inputs may include any information related to a first set of measurements and set stored rules and relationships as described herein; whereas outputs may include any information related to a structural feature model final or in its intermediary stages.

Further referring to FIG. 3, training data may be filtered, sorted, and/or selected using one or more supervised and/or unsupervised machine-learning processes and/or models as described in further detail below; such models may include without limitation a training data classifier 316. Training data classifier 316 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 300 may generate a classifier using a classification algorithm, defined as a processes whereby a computing device and/or any module and/or component operating thereon derives a classifier from training data 304. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 316 may classify elements of training data to represent various measurements of facial or dental structures and provide a basis to apply set stored rules to create a final structural feature model 124.

Still referring to FIG. 3, computing device 304 may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P (A/B)=P (B/A) P (A)=P (B), where P (A/B) is the probability of hypothesis A given data B also known as posterior probability; P (B/A) is the probability of data B given that the hypothesis A was true; P (A) is the probability of hypothesis A being true regardless of data also known as prior probability of A; and P (B) is the probability of the data regardless of the hypothesis. A naïve Bayes algorithm may be generated by first transforming training data into a frequency table. Computing device 304 may then calculate a likelihood table by calculating probabilities of different data entries and classification labels. Computing device 304 may utilize a naïve Bayes equation to calculate a posterior probability for each class. A class containing the highest posterior probability is the outcome of prediction. Naïve Bayes classification algorithm May include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 3, computing device 304 may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 3, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 3, training examples for use as training data may be selected from a population of potential examples according to cohorts relevant to an analytical problem to be solved, a classification task, or the like. Alternatively, or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively, or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or another device, or the like.

Continuing to refer to FIG. 3, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 3, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively, or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 3, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 3, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively, or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 3, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 3, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 3, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset Xₘₐₓ:

$${X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{I Q R} .$$

Persons skilled in the art, upon reviewing the entirety of this disclosure, will be aware of various alternative or additional approaches that may be used for feature scaling.

Further referring to FIG. 3, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 3, machine-learning module 300 may be configured to perform a lazy-learning process 320 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 304. Heuristic may include selecting some number of highest-ranking associations and/or training data 304 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively, or additionally, and with continued reference to FIG. 3, machine-learning processes as described in this disclosure may be used to generate machine-learning models 324. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 324 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 324 may be generated by creating an artificial neural network, such as a convolutional neural network comprising an input layer of nodes, one or more intermediate layers, and an output layer of nodes. Connections between nodes may be created via the process of “training” the network, in which elements from a training data 304 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 3, machine-learning algorithms may include at least a supervised machine-learning process 328. At least a supervised machine-learning process 328, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described above in this disclosure as inputs, outputs as described above in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 304. Persons skilled in the art, upon reviewing the entirety of this disclosure, will be aware of various possible variations of at least a supervised machine-learning process 328 that may be used to determine relation between inputs and outputs. Supervised machine-learning processes may include classification algorithms as defined above.

With further reference to FIG. 3, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively, or additionally, one or more errors and/or error function values evaluated in training iterations may be compared to a threshold.

Still referring to FIG. 3, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 3, machine learning processes may include at least an unsupervised machine-learning processes 332. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 332 may not require a response variable; unsupervised processes 332 may be used to find interesting patterns and/or inferences between variables, to determine a degree of correlation between two or more variables, or the like.

Still referring to FIG. 3, machine-learning module 300 may be designed and configured to create a machine-learning model 324 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 3, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 3, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 3, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 3, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 3, one or more processes or algorithms described above may be performed by at least a dedicated hardware unit 336. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 336 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 336 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 336 to perform one or more operations described herein, such as evaluation of model and/or algorithm outputs, one-time or iterative updates to parameters, coefficients, weights, and/or biases, and/or any other operations such as vector and/or matrix operations as described in this disclosure.

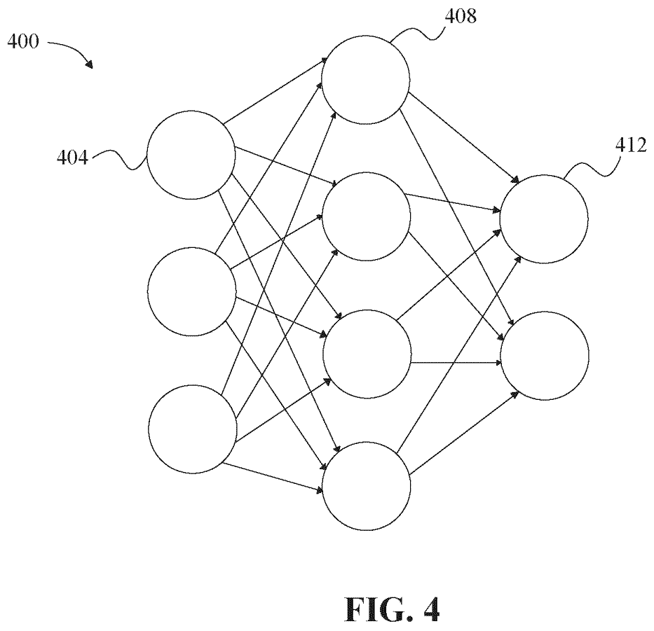

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

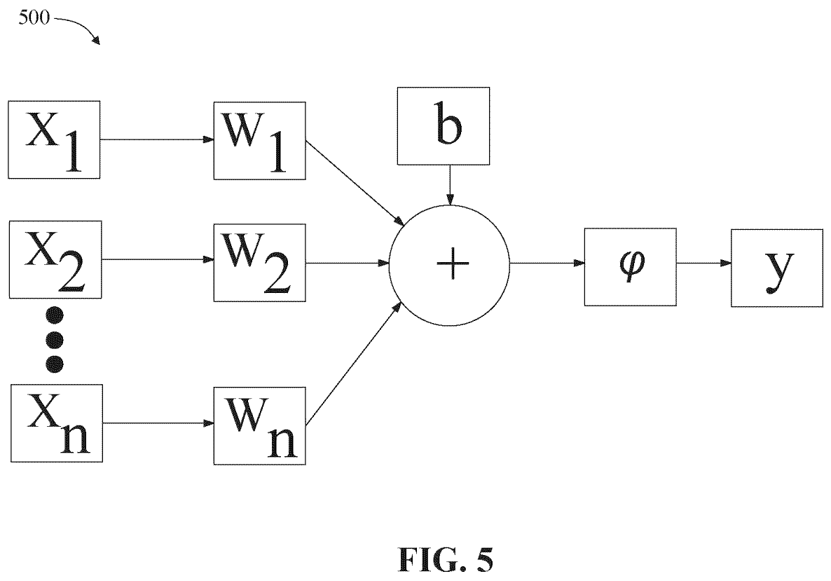

Referring now to FIG. 5, an exemplary embodiment of a node 500 of a neural network is illustrated. A node may include, without limitation a plurality of inputs x; that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max(0, x), a “leaky” and/or “parametric” rectified linear unit function such as f(x)=max(ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid (x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

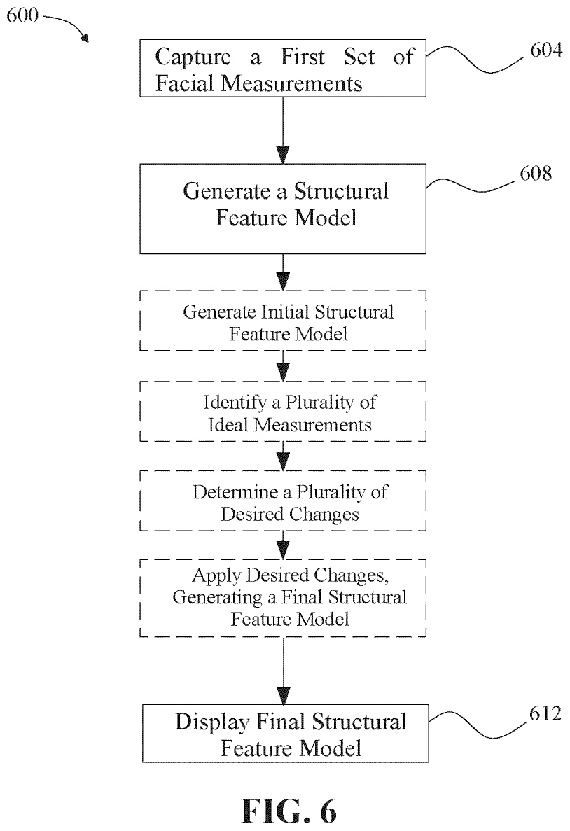

Fundamentally, there is no limit to the nature of functions of inputs xᵢ that may be used as activation functions. As a non-limiting and illustrative example, node may perform a weighted sum of inputs using weights w; that are multiplied by respective inputs xᵢ. Additionally, or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. Now referring to FIG. 6, a flow diagram illustrating an exemplary method of automated smile design modeling 600 is illustrated. A method for automated smile design modeling may include a first step including the capture of a first set of facial measurements 604. Capturing a first set of facial measurements may be done via a camera system in any embodiment as described within this disclosure. Following the capturing of a first set of facial measurements a second step may include to generate a structural feature model 608. The second step may include various sub-steps, including generating an initial structural feature model using a first set of facial measurements; identifying a plurality of ideal measurements; determining a plurality of desired changes; and applying desired changes to generate a final structural feature model. Finally, a last step may include displaying a final structural feature model 612. Steps within the step to generate a structural feature model 608 may be done continuously, until a desired smile is generated.

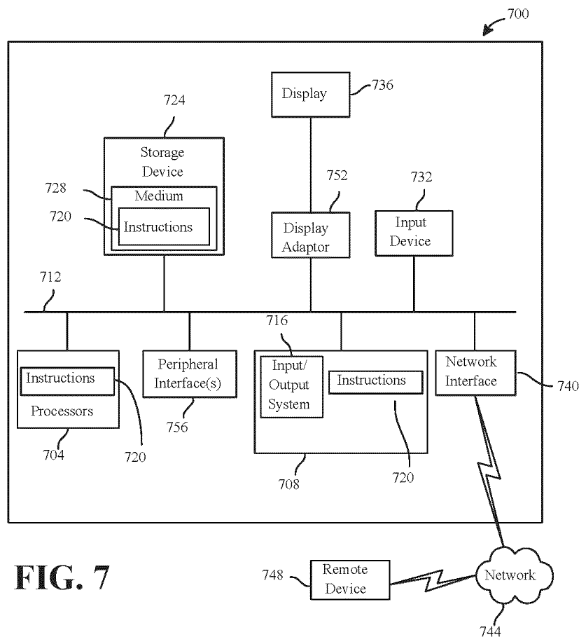

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention. Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An apparatus for automated smile design modeling, configured to:
capture at least a first set of facial measurements via a camera system;
generate a structural feature model, wherein generating a structural feature model includes;
generating an initial structural feature model using the at least a first set of facial measurements;
identifying a plurality of ideal measurements, which are identified using a data structure representing at least a stored rule that associates the first set of facial measurements with the plurality of ideal measurements;
determining a plurality of desired changes, which are identified using at least a second set of stored rules that matches the first set of facial measurements and ideal measurements to transformations to achieve ideal measurements;
applying said desired changes to the structural feature model, generating a final structural feature model; and
display said final structural feature model at a display device.

2. The apparatus of claim 1, wherein the camera system is comprised of a three-dimensional dental scanner.

3. The apparatus of claim 1, wherein the camera system is comprised of both a three-dimensional facial scanner and a three-dimensional dental scanner.

4. The apparatus of claim 1, wherein the first set of facial measurements captured by the camera system is comprised of ten individual measurements including: central incisor length (CIL), incisal display at rest, overbite, overjet, gingival display (full smile), incisal display at full smile including gums (FSD), lower incisal edge to commissure, interlabial gap with lips at rest, incisal edge to wet-dry line full smile (IEWDL), and incisal edge from vertical (IFV).

5. The apparatus of claim 1, wherein identifying a plurality of ideal measurements is accomplished with a machine-learning model.

6. The apparatus of claim 1, wherein determining a plurality of desired changes is accomplished with a machine-learning model.

7. The apparatus of claim 1, wherein the display device is a graphical user interface.

8. The apparatus of claim 1, wherein the display device allows edits to be made to the final structural feature model.

9. The apparatus of claim 1, wherein the apparatus is further configured to generate a transformation treatment report.

10. A method for automated smile design modeling, the method comprising:
capturing at least a first set of facial measurements via a camera system;
generating a structural feature model, wherein generating a structural feature model includes;
generating an initial structural feature model using the at least a first set of facial measurements;
identifying a plurality of ideal measurements, which are identified using a data structure representing at least a stored rule that associates the first set of facial measurements with the ideal measurements;
determining a plurality of desired changes, which are identified using at least a second set of stored rules that matches the first set of facial measurements and ideal measurements to transformations to achieve ideal measurements;
applying said desired changes to the structural feature model, generating a final structural feature model; and
displaying said final structural feature model at a display device.

11. The method of claim 10, wherein the camera system is comprised of a three-dimensional dental scanner.

12. The method of claim 10, wherein the camera system is comprised of both a three-dimensional face scanner and a three-dimensional dental scanner.

13. The method of claim 10, wherein the camera system captures a first set of facial measurements comprised of ten individual measurements including: central incisor length (CIL), incisal display at rest, overbite, overjet, gingival display (full smile), incisal display at full smile including gums (FSD), lower incisal edge to commissure, interlabial gap with lips at rest, incisal edge to wet-dry line full smile (IEWDL), and incisal edge from vertical (IFV).

14. The method of claim 10, wherein identifying a plurality of ideal measurements is accomplished with a machine-learning model.

15. The method of claim 10, wherein determining a plurality of desired changes is accomplished with a machine-learning model.

16. The method of claim 10, wherein the display device is a graphical user interface.

17. The method of claim 10, wherein the final structural feature model can be edited by repeating previous steps in the process.

18. The method of claim 10, wherein the final structural feature model can be edited by a user to make personalized changes based on user preference.

19. The method of claim 10, wherein the final structural feature model can be edited by a machine-learning model.

20. The method of claim 10, wherein the method further includes the generating of transformation treatment report.
